(19) United States
(12) Patent Application Publication
(10) Pub. No.: US 2020/0103568 A1
(43) Pub. Date: Apr. 2, 2020

(54) COLOR FILM SUBSTRATE AND DISPLAY PANEL

(71) Applicant: HKC Corporation Limited, Shenzhen (CN)

(72) Inventor: Beizhou Huang, Shenzhen (CN)

(21) Appl. No.: 16/254,579

(22) Filed: Jan. 22, 2019

Related U.S. Application Data
(63) Continuation of application No. PCT/CN2018/113278, filed on Nov. 1, 2018.

(30) Foreign Application Priority Data
Sep. 27, 2018 (CN) 201811136673.4

(51) Int. Cl. G02B 5/20; G02F 1/1339; G02F 1/1362

(52) U.S. Cl. CPC G02B 5/201; G02F 1/1339; G02F 2001/136222; G02F 2001/13396; G02F 1/136209

(57) ABSTRACT

The present disclosure discloses a color film substrate, a display panel and a display device. And a photoresist layer of the color film substrate is defined with a groove in a black matrix area, part of a spacer is disposed in the groove, and other part of the spacer is disposed on the photoresist layer adjacent to the periphery of the groove.

### CROSS REFERENCE TO RELATED APPLICATIONS

The present application is a Continuation Application of PCT Application No. PCT/CN2018/113278 filed on Nov. 1, 2018, which claims the benefit of Chinese Patent Application No. 201811136673.4, filed on Sep. 27, 2018, which is incorporated herein by reference in its entirety.

### FIELD

The present disclosure relates to the field of liquid crystal display technology, and in particular, relates to a color film substrate and a display panel using the color film substrate.

### BACKGROUND

In the manufacturing process of a display panel, it is necessary to manufacture a spacer between a thin film transistor (TFT) and a color film substrate (CF) for forming a gap between them, and then a liquid crystal cell is formed by filling the gap between the array substrate and the color film substrate with liquid crystal. In order to allow the liquid crystal cell to change in size in some degree so that the quantity of the liquid crystal filled therein may change in a larger range with upper and lower limits, it is necessary to make a certain height difference between the spacers. And the higher spacer is defined to determined the gap between the array substrate and the color film substrate, and the lower spacer is defined to support the surface pressure of the liquid crystal cell. In order to improve the liquid crystal cell's performance of supporting against the surface pressure, and the yield of display panel having good display effect, it is necessary to further improve the color film substrate.

### SUMMARY

The main purpose of the present disclosure is to provide a color film substrate, which aims to improve the liquid crystal cell's performance of supporting the face pressure, and the yield of display panel having good display effect.

In order to achieve the above objects, the color film substrate proposed in the present disclosure includes:

a substrate,

a black matrix, coated on the substrate and defining a plurality of light-transmissive regions on the substrate;

a photoresist layer, coated on the light-transmissive region defined by the black matrix, and part of the black matrix, and

a spacer, defined on the photoresist layer and in the area where the black matrix is disposed;

part of the photoresist layer is defined with a groove in the area where the black matrix is disposed, part of the spacer is disposed in the groove, and part of the spacer is disposed on the photoresist layer adjacent to the periphery of the groove;

Optionally, the plurality of light-transmissive regions are a first light-transmissive region, a second light-transmissive region and a third light-transmissive region defined at intervals;

the photoresist layer includes a first photoresist, a second photoresist and a third photoresist; the first photoresist, the second photoresist and the third photoresist are respectively coated on the first light-transmissive region, the second light-transmissive region and the third light-transmissive region, the first photoresist and the second photoresist are further respectively coated on part of the black matrix;

the spacer includes a first spacer and a second spacer, and the first spacerfirst spacer is coated on the first photoresist above the black matrix, the second spacer is coated on the second photoresist above the black matrix,

and the second photoresist is defined with a groove in part of the black matrix, the second spacer is partially disposed in the groove and partially disposed on the second photoresist adjacent to the periphery of the groove;

the distance between the surface of the first spacer away from the substrate and the substrate is larger than the distance between the surface of the second spacer away from the substrate and the substrate.

Optionally, the bottom of the groove penetrates through the second photoresist, and the second spacer is partially disposed on the black matrix through the groove and partially on the second photoresist adjacent to the periphery of the groove.

Optionally, and the second photoresist is defined with a plurality of grooves in part of the black matrix, the second spacer is partially disposed in the plurality of grooves and partially disposed outside the groove;

Optionally, the thickness of the first photoresist is greater than the thickness of the second photoresist.

Optionally, the thickness of the first spacer on the first photoresist is greater than the thickness of the second spacer in the second photoresist.

Optionally, the first photoresist, the second photoresist, and the third photoresist are sequentially defined in parallel.

The present disclosure also provides a color film substrate including:

a substrate,

a black matrix, the black matrix being coated on the substrate and defining a first light-transmissive region, a second light-transmissive region, and a third light-transmissive region on the substrate at intervals;

a first photoresist, coated on the first light-transmissive region and the black matrix between two adjacent first light-transmissive regions;

a second photoresist, coated on the second light-transmissive region and the black matrix between two adjacent second light-transmissive regions, the second photoresist defining a groove in the area where the black matrix is disposed;

a first spacer, coated on the first photoresist above the black matrix;

a second spacer, partially coated on the second photoresist above the black matrix, and partially disposed in the groove;

the thickness of the first photoresist is greater than the thickness of the second photoresist, the thickness of the first spacer on the first photoresist is greater than the thickness of the second spacer in the second photoresist.

The present disclosure also provides a display panel, which includes an array substrate and the color film substrate, the array substrate abuts against one end of the main spacer away from the substrate;

the color film substrate including:

a substrate,

a black matrix, coated on the substrate and defining a plurality of light-transmissive regions on the substrate;

a photoresist layer, coated on the light-transmissive region defined by the black matrix, and part of the black matrix, and

a spacer, coated on the photoresist layer and in the area where the black matrix is disposed;

part of the photoresist layer is defined with a groove in the area where the black matrix is disposed, part of the spacer is disposed in the groove,

and part of the spacer is disposed on the photoresist layer adjacent to the periphery of the groove.

The present disclosure also provides a display device, which includes a housing, a backlight module accommodated in the housing, and a display panel embedded in the housing, and light emitted by the backlight module irradiates the display panel, and the display panel displays an image;

the a display panel includes an array substrate and the color film substrate, the array substrate abuts against one end of the main spacer away from the substrate;

the color film substrate including:

a substrate,

a black matrix, coated on the substrate and defining a plurality of light-transmissive regions on the substrate;

a photoresist layer, coated on the light-transmissive region defined by the black matrix, and part of the black matrix, and

a spacer, defined on the photoresist layer and in the area where the black matrix is disposed;

part of the photoresist layer is defined with a groove in the area where the black matrix is disposed, part of the spacer is disposed in the groove, and part of the spacer is disposed on the photoresist layer adjacent to the periphery of the groove.

In the technical schemes of the present disclosure, the photoresist layer of the color film substrate is coated with a spacer, and the photoresist layer is defined with a groove, part of the spacer is disposed in the groove on the photoresist layer and part of the spacer is disposed on the photoresist layer adjacent to the periphery of the groove, thereby the thickness of the spacer in the groove is different with the thickness of the spacer outside the groove. When the display panel using the color film substrate is subjected to external pressure, the part of the spacer in the groove and the part outside the groove have different compression degrees, generating at least two different resilience forces, thereby the spacer's performance of supporting against surface pressure is improved.

### BRIEF DESCRIPTION OF THE DRAWINGS

In order to more clearly explain the embodiments of the present disclosure or the technical solutions in the prior art, the drawings that need to be used in the embodiments or the description of the prior art will be briefly introduced below. Obviously, the drawings in the following description are only some embodiments of the present disclosure. For those of ordinary skill in the art, other drawings maybe obtained according to the structures shown in these drawings without paying creative labor.

FIG. 1 is a cross-sectional view of a portion of the structure of a color film substrate in some embodiments of the present disclosure;

FIG. 2 is a cross-sectional view of a portion of the structure of a display panel in some embodiments of the present disclosure.

### BRIEF DESCRIPTION OF THE DRAWINGS

TABLE 1

| Label | Name | Label | Name |
|---|---|---|---|
| 100 | Color film substrate | 321 | Groove |
| 10 | Substrate | 40 | Spacer |
| 20 | Black matrix | 41 | First spacer |
| 30 | Photoresist layer | 42 | Second spacer |
| 31 | First photoresist | 200 | Array substrate |
| 32 | Second photoresist | | |

The realization, functional features and advantages of the purpose of the present disclosure will be further described with reference to the accompanying drawings in conjunction with the embodiments.

### DETAILED DESCRIPTION OF THE EMBODIMENTS

The technical solutions of the embodiments of the present disclosure will be clearly and completely described in the following with reference to the accompanying drawings. It is obvious that the embodiments to be described are only a part rather than all of the embodiments of the present disclosure. All other embodiments obtained by persons skilled in the art based on the embodiments of the present disclosure without creative efforts shall fall within the protection scope of the present disclosure.

It should be noted that all directional indications (such as up, down, left, right, front, back, etc.) in the embodiments of the present disclosure are only set to explain the relative positional relationship, movement, etc. between the components in a certain posture (as shown in the drawings), and if the specific posture changes, the directional indication changes accordingly.

In addition, in this disclosure, the descriptions such as “first” and “second” are set for the purpose of description only, and are not to be understood as indicating or implying its relative importance or implicitly indicating the number of indicated technical features. Thus, features defining “first” and “second” may explicitly or implicitly include at least one such feature. In addition, the technical solutions between the various embodiments may be combined with each other, but must be based on what one of ordinary skill in the art can achieve. When the combination of technical solutions is contradictory or impossible to achieve, it should be considered that the combination of such technical solutions does not exist and is not within the scope of protection required by this disclosure.

The present disclosure proposes a color film substrate 100. The color film substrate 100 includes a color film substrate 100 and a spacer disposed on the color film substrate 100. The color film substrate 100 and the array substrate 200 are disposed facing to each other in the display panel of the liquid crystal displayer, and the spacer is defined between the color film substrate 100 and the array substrate 200 for supporting the color film substrate 100 and the array substrate 200. The spacer defined with different heights may play a uniform role in the flowing liquid crystal layer between the color film substrate 100 and the array substrate 200, and may ensure the quantity of the liquid crystal filled and prevent adverse effect caused by liquid crystal dropping error on the product.

The segment difference among the spacer is determined by the thickness of the spacer itself and the height of the upper surface of the photoresist layer 30 from the substrate 10. In the manufacturing process of the spacers 50, Gray Tone masks or Half Tone masks are used under different exposure to control the position and thickness of the spacer. Increasing the segment difference among the spacers by adjusting the thickness of the spacer 50 makes it necessary to change different Gray Tone mask or Half Tone mask, however the Gray Tone mask or Half Tone mask is relatively expensive, thus increasing the manufacturing cost of the color film substrate 100.

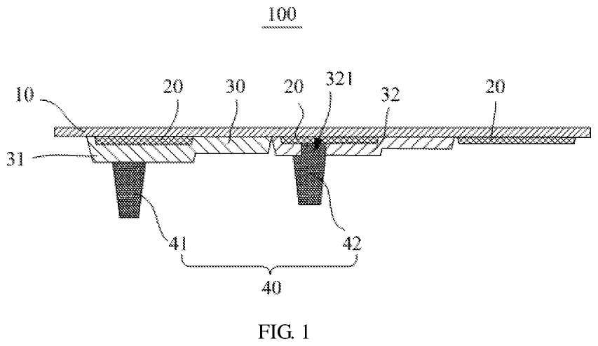

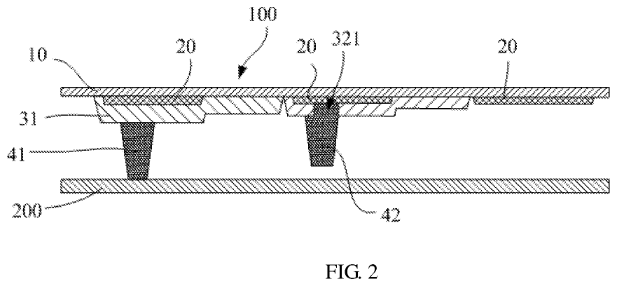

Referring to FIGS. 1 and 2, in some embodiments of the present disclosure, the color film substrate 100 includes:

a base 10,

a black matrix 20, coated on the substrate 10 and defining a plurality of light-transmissive regions on the substrate 10;

a photoresist layer 30, coated on the light-transmissive region defined by the black matrix 20, and part of the black matrix 20, and

a spacer 40, defined on the photoresist layer 30 and in the area where the black matrix 20 is disposed;

part of the photoresist layer 30 is defined with a groove 321 in the area where the black matrix 20 is disposed, part of the spacer 40 is disposed in the groove 321, and part of the spacer 40 is disposed on the photoresist layer 30 adjacent to the periphery of the groove 321.

In the technical schemes of the present disclosure, the color film substrate 100 is aligned with the array substrate 200 to form a display panel, and the photoresist layer 30 of the color film substrate 100 is coated with a spacer 40, which is partially disposed in the groove 321 on the photoresist layer 30 and partially disposed on the photoresist layer 30 adjacent to the groove 321. Thereby the thickness of the spacer in the groove is different with the thickness of the spacer outside the groove. When the display panel is subjected to external pressure, the part of the spacer 40 in the groove 321 and the part outside the groove 321 have different compression degrees, generating at least two different resilience forces, thereby the spacer's performance of supporting against surface pressure is improved.

Further, the plurality of light-transmissive regions are a first light-transmissive region, a second light-transmissive region and a third light-transmissive region defined at intervals;

the photoresist layer 30 includes a first photoresist 31, a second photoresist 32, and a third photoresist; the first photoresist 31, the second photoresist 32 and the third photoresist are respectively coated on the first light-transmissive region, the second light-transmissive region and the third light-transmissive region, the first photoresist and the second photoresist are further respectively coated on part of the black matrix;

the spacer 40 includes a first spacer 41 coated on the first photoresist 31 above the black matrix 20 and a second spacer 42 coated on the second photoresist 32 above the black matrix 20. The part of the second photoresist 32 on the black matrix 20 defines a groove 321, and the second spacer 42 is partially disposed in the groove 321 and partially disposed on the second photoresist 32 adjacent to the periphery of the groove 321.

The distance between the surface of the first spacer 41 away from the substrate and the substrate is larger than the distance between the surface of the second spacer 42 away from the substrate and the substrate.

The substrate 10 is formed with a first attachment area, a second attachment area and a third attachment area, which are defined in a strip shape and respectively include a plurality of light-transmissive regions defined along the strip shape and opaque areas disposed between two adjacent light-transmissive regions. Commonly, the first attachment area, the second attachment area and the third attachment area are respectively defined to coat the first photoresist 31, the second photoresist 32 and the third photoresist. That is, the first photoresist 31 is coated on a plurality of the first light-transmissive regions of the first attachment area, and a black matrix 20 between two adjacent light-transmissive regions; the second photoresist 32 is coated on a plurality of the second light-transmissive regions of the second attachment area, and a black matrix 20 between two adjacent light-transmissive regions; the third photoresist is coated on a plurality of the second light-transmissive regions of the third attachment area, and a black matrix 20 between two adjacent light-transmissive regions. Optionally, the first photoresist 31 is only coated on a plurality of light-transmissive regions of the first attachment area, the second photoresist 32 is coated only on a plurality of light-transmissive regions of the second attachment area, and the third photoresist is coated only on a plurality of light-transmissive regions of the third attachment area.

In the technical schemes of the present disclosure, the first photoresist 31 and the second photoresist 32 are also coated on part of the black matrix 20. That is, the first photoresist 31 is coated on a plurality of the first light-transmissive regions of the first attachment area, and a black matrix 20 between two adjacent light-transmissive regions; the second photoresist 32 is coated on a plurality of the second light-transmissive regions of the second attachment area, and a black matrix 20 between two adjacent light-transmissive regions. And the first spacer 41 is coated on the first photoresist 31 above the black matrix 20. and the second spacer 42 is coated on the second photoresist 32 above the black matrix 20. The distance between the surface of the first spacer 41 away from the substrate and the substrate is larger than the distance between the surface of the second spacer 42 away from the substrate and the substrate. After the array substrate 200 and the color film substrate 100 are aligned to form a display panel, the first spacer 41 abuts against the array substrate 200, mainly supporting the liquid crystal cell gap. When the display panel is pressed, the array substrate 200 or the color film substrate 100 is bent, and the second spacer 42 abuts against the array substrate 200, mainly supporting against the surface pressure. The second photoresist 32 is defined with a groove 321 on part of the black matrix 20, and the second spacer 42 is partially disposed in the groove 321 and partially disposed on the second photoresist 32 adjacent to the groove 321, so that the second spacer 42 may generate at least two resilience forces of different magnitudes in the process of supporting against the surface pressure, thereby supporting against the surface pressure better.

Further, the bottom of the groove 321 penetrates the second photoresist 32. The second spacer 42 partially penetrates the groove 321 and locating on the black matrix 20, and partially locating on the second photoresist 32 adjacent to the periphery of the groove 321.

In this embodiment, the bottom of the groove 321 is defined through, that is, the portion of the second photoresist 32 in the groove 321 is directly attached to the black matrix 20, and the difference in thickness between the portion of the second photoresist 32 in the groove 321 and the portion outside the groove 321 is further increased in this structure, so that the resilience force from the second photoresist 32 is in good cooperation while the display panel is under compression.

It may be appreciated that in other technical schemes of the present disclosure, a groove may be provided in the portion of the first photoresist disposed in the area where the black matrix 20 is disposed, and the first spacer 41 may be partially defined in the groove when the spacer 40 is manufactured.

The first spacer is partially formed on the first photoresist adjacent to the periphery of the groove, so that the first spacer used to support the color film substrate and the array substrate may generate different resilience, thereby improving the support effect of the spacer.

The surface of the free end of the second spacer 42 is flat, that is, the array substrate 200 contacts the surface of the free end of the second spacer 42 when being under compression, and simultaneously applies force to the portion of the second spacer 42 inside the groove 321 and the portion outside the groove 321. The two portions of the second spacer 42 with different thicknesses may distribute the pressure to different degrees, thereby enhancing the supporting effect of the surface pressure of the spacer 40.

It may be understood that the groove 321 on the second photoresist 32 may not penetrate through the second photoresist 32, and the depth of the groove 321 is relatively shallow compared with the above embodiment, which maybe realized by controlling the exposure of the portion during the manufacturing process of the second photoresist 32.

Further, in other technical schemes of the present disclosure, the second photoresist is defined with a plurality of grooves in part of the black matrix, and the second spacer is partially disposed in the grooves and partially disposed outside the grooves.

The second photoresist 32 may also be defined with two or more grooves 321, and two adjacent grooves 321 may be spaced apart. The depths of the grooves 321 may or may not be uniform. The second spacer 42 may be filled in the two or more grooves 321 at the same time and partially disposed on the second photoresist 32 outside the grooves 321, so that the second spacer 42 may provide more different resilience forces during supporting the surface pressure.

In the embodiment of the present disclosure, the thickness of the first photoresist 31 is greater than the thickness of the second photoresist 32. In this embodiment, the own height of the first spacer 41 is greater than the own height of the second spacer 42, thereby the thickness of the first spacer 41 on the first photoresist 31 in this embodiment may be the same as the thickness of the second spacer 42 on the second photoresist 32, or may be inconsistent. When the thickness of the first spacer 41 on the first photoresist 31 is the same as the thickness of the second spacer 42 on the second photoresist 32, the manufacturing process may be further simplified and the improvement on the manufacturing equipment may be simplified.

The segment difference between the free ends of the first spacer 41 and the second spacer 42 may be realized by its own thickness difference, or may be realized in combination with the thickness difference between the first photoresist 31 and the second photoresist 32. In the embodiment of the present disclosure, the thickness of the first spacer 41 in the first photoresist 31 is greater than the thickness of the second spacer in the second photoresist 32, so that the segment difference between the free ends of the first spacer 41 and the second spacer 42 maybe further increased, thereby further increasing the crystal liquid quantity limit (LC margin of liquid crystal) between the color film base plate 100 and the array substrate 200 and improving the yield of the display panel.

Further, the contact area between the first spacer 41 and the first photoresist 31 is larger than the contact area between the second spacer 42 and the second photoresist 32.

Referring to FIG. 1, the first photoresist 31, the second photoresist 32, and the third photoresist are sequentially defined in parallel.

The photoresist layer 30 has three color layers of different colors, namely, the first photoresist 31, the second photoresist 32, and the third photoresist. The first photoresist 31, the second photoresist 32, and the third photoresist may be a blue photoresist, a green photoresist, and a red photoresist, respectively. In this embodiment, the first spacer 41 is disposed on the surface of the blue photoresist, and the first spacer 41 on the blue layer supports the array substrate 200. The first spacer 41 is disposed on the surface of the green photoresist,

and is defined to support surface force. The technical schemes of the present disclosure may also provide a third spacer on the red photoresist, so that the spacer on the color film substrate 100 has multiple segment differences to further increase the support effect of the surface pressure, and further, a groove may also be provided in the red photoresist, so that the third spacer is partially disposed in the groove and partially disposed on the red photoresist outside the groove, thereby further improving the support strength of the spacer 40 against surface pressure.

When the first photoresist 31, the second photoresist 32, and the third photoresist are sequentially defined in parallel, the first photoresist 31, the second photoresist 32, and the third photoresist may also be blue photoresist, green photoresist, and red photoresist, respectively, so that the display panel using the color film substrate 100 may have different effects of support against surface pressure.

In other embodiments of the technical schemes of the present disclosure, the first photoresist 31, the third photoresist and the second photoresist 32 are sequentially defined in parallel so that the first spacer 41 and the second spacer 42 are defined at intervals in the pixel region on the color film substrate 100.

It will be understood that the above-mentioned first photoresist 31, second photoresist 32 and third photoresist are not limited to the above-mentioned arrangement, but may also be defined in other arrangements of the blue layer, green layer and red layer, or not limited to the blue layer, green layer and red layer, and may also be photoresist layers 30 of other colors, all within the scope of protection of the present disclosure.

The present disclosure also provides a color film substrate including:

a substrate,

a black matrix, the black matrix being coated on the substrate and defining a first light-transmissive region, a second light-transmissive region, and a third light-transmissive region on the substrate at intervals;

a first photoresist, coated on the first light-transmissive region and the black matrix between two adjacent first light-transmissive regions;

a second photoresist, coated on the second light-transmissive region and the black matrix between two adjacent second light-transmissive regions, the second photoresist defining a groove in the area where the black matrix is disposed;

a first spacer, coated on the first photoresist above the black matrix;

a second spacer, partially coated on the second photoresist above the black matrix, and partially disposed in the groove;

the thickness of the first photoresist is greater than the thickness of the second photoresist, the thickness of the first spacer on the first photoresist is greater than the thickness of the second spacer in the second photoresist.

In this embodiment, since the thickness of the first photoresist is greater than the thickness of the second photoresist, a natural terrain difference maybe formed to pad the first spacer, even if the thickness of the first spacer at the first photoresist is equal to the thickness of the second spacer on the second photoresist, the surface of the first spacer facing away from the substrate may also be higher than the surface of the second spacer facing away from the base plate. In this embodiment, the thickness of the first spacer on the first photoresist is greater than the thickness of the second spacer on the second photoresist, further increasing the segment differences between the first spacer and the second spacer, which not only increasing LC Margine of the liquid crystal between the color film substrate 100 and the array substrate 200, and improving the yield of the display panel, but also allowing the second spacer 42 under surface pressure to generate at least two resilience forces of different magnitudes, resulting in better effect of support against the surface pressure.

The present disclosure also proposes a display panel including an array substrate 200 and a color film substrate 100. The structure of the color film substrate 100 refers to the above embodiments. Since the display panel adopts all the technical solutions of all the above embodiments, it has at least all the beneficial effects brought about by the technical solutions of the above embodiments and will not be described in detail here. The array substrate 200 abuts against one end of the main spacer away from the color film substrate 100.

The present disclosure also provides a display device including an array substrate 200 and a color film substrate 100. The structure of the color film substrate 100 refers to the above embodiments. Since the display panel adopts all the technical solutions of all the above embodiments, it has at least all the beneficial effects brought about by the technical solutions of the above embodiments and will not be described here. The array substrate 200 abuts against one end of the main spacer away from the color film substrate 100. The display device maybe a liquid crystal display, a television display, a computer display, or a display screen of other medical and engineering detection instruments, as well as a display screen of Thin Film Transistor or wearing equipment.

The above is only an optional embodiment of the present disclosure and is not therefore limiting the scope of the patent disclosure. Any equivalent structural change made by using the contents of the specification and drawings of the present disclosure or directly/indirectly applied in other related technical fields is included in the scope of the patent protection of the present disclosure under the inventive concept of the present disclosure.

What is claimed is:

1. A color film substrate, wherein the color film substrate comprises:
a substrate;
a black matrix, wherein the black matrix is coated on the substrate and defines a plurality of light-transmissive regions on the substrate;
a photoresist layer, coated on the light-transmissive region defined by the black matrix, and part of the black matrix; and
a spacer, wherein the spacer is defined on the photoresist layer and in the area where the black matrix is disposed;
part of the photoresist layer is defined with a groove in the area where the black matrix is disposed, part of the spacer is disposed in the groove, and part of the spacer is disposed on the photoresist layer adjacent to the periphery of the groove.

2. The color film substrate according to claim 1, wherein the plurality of light-transmissive regions are a first light-transmissive region, a second light-transmissive region and a third light-transmissive region defined at intervals; the photoresist layer comprises a first photoresist, a second photoresist and a third photoresist; the first photoresist, the second photoresist and the third photoresist are respectively coated on the first light-transmissive region, the second light-transmissive region and the third light-transmissive region,
the first photoresist and the second photoresist are further respectively coated on part of the black matrix; the spacer comprises a first spacer and a second spacer, wherein the first spacer is coated on the first photoresist above the black matrix, the second spacer is coated on the second photoresist above the black matrix, and the second photoresist is defined with a groove in part of the black matrix,
the second spacer is partially disposed in the groove and partially disposed on the second photoresist adjacent to the periphery of the groove; and the distance between the surface of the first spacer away from the substrate and the substrate is larger than the distance between the surface of the second spacer away from the substrate and the substrate.

3. The color film substrate according to claim 2, wherein the bottom of the groove penetrates through the second photoresist, and the second spacer is partially disposed on the black matrix through the groove and partially on the second photoresist adjacent to the periphery of the groove.

4. The color film substrate according to claim 2, wherein the second photoresist is defined with a plurality of grooves in part of the black matrix, and the second spacer is partially disposed in the grooves and partially disposed outside the grooves.

5. The color film substrate according to claim 2, wherein the thickness of the first photoresist is greater than the thickness of the second photoresist.

6. The color film substrate according to claim 3, wherein the thickness of the first photoresist is greater than the thickness of the second photoresist.

7. The color film substrate according to claim 2, wherein the thickness of the first spacer on the first photoresist is greater than the thickness of the second spacer in the second photoresist.

8. The color film substrate according to claim 3, wherein the thickness of the first spacer on the first photoresist is greater than the thickness of the second spacer in the second photoresist.

9. The color film substrate according to claim 5, wherein the thickness of the first spacer on the first photoresist is greater than the thickness of the second spacer in the second photoresist.

10. The color film substrate according to claim 2, wherein the first photoresist, the second photoresist, and the third photoresist are sequentially defined in parallel.

11. The color film substrate according to claim 3, wherein the first photoresist, the second photoresist, and the third photoresist are sequentially defined in parallel.

12. The color film substrate according to claim 5, wherein the first photoresist, the second photoresist, and the third photoresist are sequentially defined in parallel.

13. The color film substrate according to claim 7, wherein the first photoresist, the second photoresist, and the third photoresist are sequentially defined in parallel.

14. A color film substrate, wherein the color film substrate comprises:
a substrate;
a black matrix, wherein the black matrix is coated on the substrate and defines a first light-transmissive region, a second light-transmissive region, and a third light-transmissive region on the substrate at intervals;
a first photoresist, coated on the first light-transmissive region and the black matrix between two adjacent first light-transmissive regions;
a second photoresist, coated on the second light-transmissive region and the black matrix between two adjacent second light-transmissive regions, the second photoresist defining a groove in the area where the black matrix is disposed;
a first spacer, coated on the first photoresist above the black matrix; and
a second spacer, partially coated on the second photoresist above the black matrix, and partially disposed in the groove; the thickness of the first photoresist is greater than the thickness of the second photoresist, the thickness of the first spacer on the first photoresist is greater than the thickness of the second spacer in the second photoresist.

15. A display panel, comprising an array substrate and the color film substrate;
the color film substrate comprising:
a substrate;
a black matrix, wherein the black matrix is coated on the substrate and defines a plurality of light-transmissive regions on the substrate; a photoresist layer, coated on the light-transmissive region defined by the black matrix, and part of the black matrix; and
a spacer, wherein the spacer is defined on the photoresist layer and in the area where the black matrix is disposed; part of the photoresist layer is defined with a groove in the area where the black matrix is disposed, part of the spacer is disposed in the groove, and part of the spacer is disposed on the photoresist layer adjacent to the periphery of the groove; the array substrate abuts against one end of the spacer away from the substrate.

16. The display panel according to claim 15, wherein the plurality of light-transmissive regions are a first light-transmissive region, a second light-transmissive region and a third light-transmissive region defined at intervals; the photoresist layer comprises a first photoresist, a second photoresist and a third photoresist; the first photoresist, the second photoresist and the third photoresist are respectively coated on the first light-transmissive region, the second light-transmissive region and the third light-transmissive region,
the first photoresist and the second photoresist are further respectively coated on part of the black matrix; the spacer comprises a first spacer and a second spacer, wherein the first spacer is coated on the first photoresist above the black matrix, the second spacer is coated on the second photoresist above the black matrix, and the second photoresist is defined with a groove in part of the black matrix,
the second spacer is partially disposed in the groove and partially disposed on the second photoresist adjacent to the periphery of the groove; and the distance between the surface of the first spacer away from the substrate and the substrate is larger than the distance between the surface of the second spacer away from the substrate and the substrate.

17. The display panel according to claim 16, wherein the bottom of the groove penetrates through the second photoresist, and the second spacer is partially disposed on the black matrix through the groove and partially on the second photoresist adjacent to the periphery of the groove.

18. The display panel according to claim 17, wherein the thickness of the first photoresist is greater than the thickness of the second photoresist.

19. The display panel according to claim 17, wherein the thickness of the first spacer on the first photoresist is greater than the thickness of the second spacer in the second photoresist.

20. The display panel according to claim 18, wherein the thickness of the first spacer on the first photoresist is greater than the thickness of the second spacer in the second photoresist.
